(19) United States
(12) Patent Application Publication
(10) Pub. No.: US 2026/0016988 A1
(43) Pub. Date: Jan. 15, 2026

(54) COMPUTING SYSTEM FOR STORING DATA AND METHOD OF OPERATING THE SAME

(71) Applicant: SK hynix Inc., Gyeonggi-do (KR)

(72) Inventors: Eun Soo JANG, Gyeonggi-do (KR); Gyeong Su YOO, Gyeonggi-do (KR)

(21) Appl. No.: 19/046,540

(22) Filed: Feb. 6, 2025

(30) Foreign Application Priority Data
Jul. 9, 2024 (KR) 10-2024-0090478

(51) Int. Cl. G06F 3/06

(52) U.S. Cl. CPC G06F 3/0659; G06F 3/0611; G06F 3/0679

(57) ABSTRACT

Provided herein may be a computing system for storing data and a method of operating the same. The computing system may include a host device configured to output a write operation request for a plurality of pieces of data corresponding to a plurality of consecutive logical addresses, and a storage device including a plurality of memory areas to be operated according to an interleaving scheme, the storage device configured to, when the write operation request is received from the host device, determine a write order of the plurality of pieces of data so that the pieces of data are read from the plurality of memory areas according to a sequential order of the plurality of logical addresses during a read operation, and provide, to the host device, data transmission requests corresponding to each of the plurality of pieces of data based on the determined write order.

### CROSS-REFERENCE TO RELATED APPLICATION

The present application claims priority under 35 U.S.C. § 119 (a) to Korean patent application number 10-2024-0090478 filed on Jul. 9, 2024, the entire disclosure of which is incorporated by reference herein.

### BACKGROUND

### 1. Field of Invention

Various embodiments of the present disclosure generally relate to a semiconductor device, and more particularly to a computing system for storing data and a method of operating the computing system.

### 2. Description of Related Art

A storage device may be a device which stores data under the control of a host device. The storage device may include a memory device which stores data, a buffer memory which temporarily stores data, and a memory controller which controls the memory device and the buffer memory.

The host device and the storage device may communicate with each other using data packets, each called a protocol information unit (PIU). The protocol information unit may be a type of data packet generated based on a predefined standard. The storage device may control the order in which data is received from the host device through a protocol information unit.

The storage device may perform a one-shot write operation in which a plurality of pieces of logical page data are stored at once in a memory area during a write operation. In this case, when the order in which the pieces of data are received from the host device is not controlled, pieces of data corresponding to consecutive logical addresses may be stored in one memory area. However, because a read operation of the storage device sequentially reads one piece of logical page data from each of a plurality of memory areas according to an interleaving scheme, the logical addresses of pieces of data read from the plurality of memory areas, respectively, may be nonconsecutive. Therefore, there is a need to control the order in which pieces of data are received from the host device during a write operation so that logical addresses are consecutively read in order during a subsequent read operation.

### SUMMARY

Various embodiments of the present disclosure are directed to a computing system that is capable of improving the performance of a read operation, and a method of operating the computing system.

An embodiment of the present disclosure may provide for a computing system. The computing system may include a host device configured to output a write operation request for a plurality of pieces of data corresponding to a plurality of consecutive logical addresses, and a storage device including a plurality of memory areas to be operated according to an interleaving scheme, the storage device configured to, when the write operation request is received from the host device, determine a write order of the plurality of pieces of data so that the pieces of data are read from the plurality of memory areas according to a sequential order of the plurality of logical addresses during a read operation on the plurality of logical addresses, and provide, to the host device, data transmission requests corresponding to each of the plurality of pieces of data based on the determined write order.

An embodiment of the present disclosure may provide for a method of operating a storage device including a plurality of memory areas to be operated according to an interleaving scheme. The method may include receiving, from a host device, a write operation request for a plurality of pieces of data corresponding to a plurality of consecutive logical addresses, determining a write order of the plurality of pieces of data so that the pieces of data are read from the plurality of memory areas according to a sequential order of the plurality of logical addresses during a read operation corresponding to the plurality of logical addresses, providing, to the host device, data transmission requests corresponding to each of the plurality of pieces of data to the host device based on the determined write order, sequentially receiving, from the host device, the plurality of pieces of data corresponding to the data transmission requests according to the determined write order, and storing the plurality of pieces of data in the plurality of memory areas according to the determined write order.

An embodiment of the present disclosure may provide for a computing system. The computing system may include a host device configured to output a write operation request for a plurality of pieces of data corresponding to a plurality of consecutive logical addresses, a memory device including a plurality of memory areas to be operated according to an interleaving scheme, and a memory controller, in response to the write operation request, configured to determine an order in which the plurality of pieces of data are to be stored in the plurality of memory areas based on an order in which the pieces of data are read from the plurality of memory areas, and provide, to the host device, data transmission requests corresponding to each of the plurality of pieces of data so that the plurality of pieces of data are transmitted from the host device according to the determined order.

### BRIEF DESCRIPTION OF THE DRAWINGS

FIG. 1 is a diagram illustrating a computing system according to an embodiment of the present disclosure.

FIGS. 2A and 2B are diagrams illustrating a plurality of memory areas according to an embodiment of the present disclosure.

FIG. 3 is a diagram illustrating a write operation according to an embodiment of the present disclosure.

FIG. 4 is a diagram illustrating a write operation performed in a write order according to an embodiment of the present disclosure.

FIG. 5 is a sequence diagram illustrating data transmission requested from a host device in a write order according to an embodiment of the present disclosure.

FIG. 6 is a sequence diagram illustrating data transmission requested from a host device in a write order according to an embodiment of the present disclosure.

FIG. 7 is a diagram illustrating a data transmission request according to an embodiment of the present disclosure.

FIG. 8 is a diagram illustrating a read operation performed according to an embodiment of the present disclosure.

FIG. 9 is a flowchart illustrating a method of operating a computing system according to an embodiment of the present disclosure.

FIG. 10 is a diagram illustrating a memory controller according to an embodiment of the present disclosure.

### DETAILED DESCRIPTION

Specific structural or functional descriptions in the embodiments of the present disclosure introduced in this specification are provided as examples to describe embodiments according to the concept of the present disclosure. The embodiments according to the concept of the present disclosure may be practiced in various forms and should not be construed as being limited to the embodiments described in the specification.

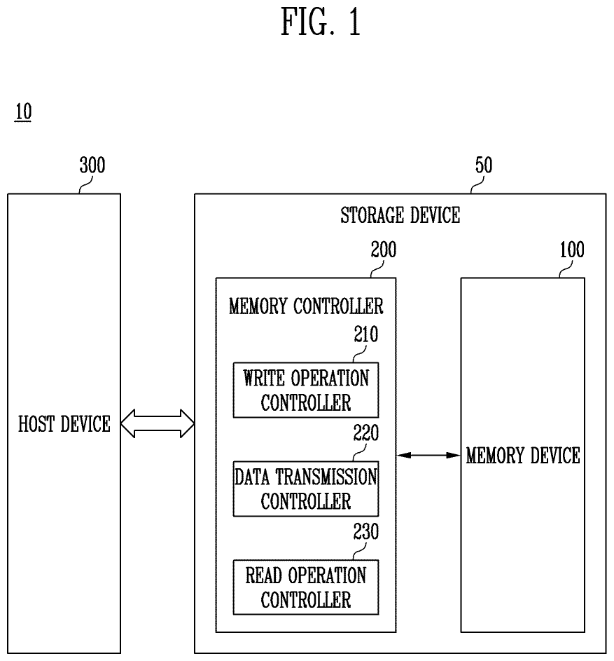

FIG. 1 is a diagram illustrating a computing system according to an embodiment of the present disclosure.

Referring to FIG. 1, a computing system 10 may include a storage device 50 and a host device 300. In an embodiment, the computing system 10 may be a system, such as a mobile phone, a smart phone, an MP3 player, a laptop computer, a server computer, a desktop computer, a TV, a tablet PC, or an in-vehicle infotainment system, which is configured to process various types of information.

The storage device 50 may be a device which stores data under the control of the host device 300.

The storage device 50 may include a memory device 100 and a memory controller 200 which controls the operation of the memory device 100.

The storage device 50 may be implemented as any storage devices such as a solid state drive (SSD), an MMC or eMMC type-multimedia card, a universal serial bus (USB) storage device, a universal flash storage (UFS) device, a peripheral component interconnection (PCI) or PCI express (PCI-E) card-type storage device, a compact flash (CF) card, a smart media card, and a memory stick, depending on a method for communication with the host device 300. In the present specification, for convenience of description, description will be made based on that the memory device 100 is a UFS device.

The storage device 50 may be manufactured in any of various types of package forms. For example, the storage device 50 may be manufactured in any of various types of package forms, such as package on package (POP), system in package (SIP), system on chip (SOC), multi-chip package (MCP), chip on board (COB), wafer-level fabricated package (WFP), and wafer-level stack package (WSP).

The memory device 100 may store data. The memory device 100 may include a plurality of memory blocks which store data. Each memory block may include a plurality of memory cells. Each of the memory cells may be implemented as a single-level cell (SLC) in which one data bit is stored. Further, according to an embodiment, each of the memory cells may be implemented as a multi-level cell (MLC) in which two data bits are stored, a triple-level cell (TLC) in which three data bits are stored, or a quad-level cell (QLC) in which four data bits are stored. In the present disclosure, for convenience of description, description will be made based on that each memory cell is implemented as a triple-level cell.

In an embodiment, the memory device 100 may include a plurality of memory areas. The plurality of memory areas may refer to areas in which data is stored, and may represent areas, such as planes or dies, to be operated according to an interleaving scheme. Each of the memory areas may include a plurality of memory blocks. In an embodiment, the numbers of memory blocks respectively included in the plurality of memory areas may be different from each other or identical to each other.

In an embodiment, the memory device 100 may be a nonvolatile memory in which data is retained even when power is interrupted. In the present specification, for convenience of description, description will be made based on that the memory device 100 is a NAND flash memory.

In an embodiment, the memory device 100 may receive a command and an address from the memory controller 200. The command may be a command generated by the memory controller 200 to control the operation of the memory device 100. The memory device 100 may perform an operation indicated by the command on the area selected by the address. For example, the memory device 100 may perform a write operation (or a program operation), a read operation, and an erase operation.

The memory controller 200 may control the overall operation of the storage device 50.

In an embodiment, the memory controller 200 may include a processor which runs firmware (FW), a memory which stores the firmware, a host interface which communicates with the host device 300, a memory interface which communicates with the memory device 100, etc.

When power is applied to the storage device 50, the memory controller 200 may run the firmware (FW). When the memory device 100 is a flash memory device, the firmware (FW) may include a host interface layer (HIL) which controls communication with the host device 300, a flash translation layer (FTL) which controls communication between the host device 300 and the memory device 100, and a flash interface layer (FIL) which controls communication with the memory device 100.

In an embodiment, the memory controller 200 may receive data and a logical block address (LBA) from the host device 300, and may translate the logical block address (LBA) into a physical block address (PBA) indicating the address of memory cells which are included in the memory device 100 and in which the data is to be stored. In the present specification, a logical block address and a “logical address” may be used interchangeably with each other. In the present specification, a physical block address and a “physical address” may be used interchangeably with each other.

In an embodiment, the memory controller 200 may control the memory device 100 so that a write operation, a read operation or an erase operation is performed in response to the request of the host device 300. For example, the memory controller 200 may provide an internal command, an address, and data required to perform the write operation, the read operation or the erase operation to the memory device 100.

In an embodiment, the memory controller 200 may control the plurality of memory areas according to an interleaving scheme to improve operational performance. The interleaving scheme may be a scheme for controlling the memory areas so that the operations of at least two memory areas overlap each other.

In an embodiment, the memory controller 200 may include a write operation controller 210, a data transmission controller 220, and a read operation controller 230.

The write operation controller 210 may control a write operation of storing data in the memory device 100 in response to a write request received from the host device 300.

In an embodiment, the write operation controller 210 may receive a write operation request for a plurality of pieces of data corresponding to a plurality of consecutive logical addresses from the host device 300.

The data transmission controller 220 may control the order in which pieces of write data corresponding to the write operation request are received from the host device 300.

In an embodiment, the data transmission controller 220 may control the order in which the pieces of data are received based on the sequential order of the plurality of logical addresses in response to the write operation request. In an embodiment, the order in which the pieces of data are received may correspond to the write order of data. For example, the data transmission controller 220 may determine the write order so that, after a plurality of pieces of data corresponding to a plurality of logical addresses are stored in a plurality of memory areas, the pieces of data are read from the plurality of memory areas according to the sequential order of the plurality of logical addresses during a read operation on the logical addresses.

In an embodiment, the data transmission controller 220 may provide data transmission requests corresponding to each of the plurality of pieces of data, to the host device based on the determined write order.

In an embodiment, the write operation controller 210 may receive a plurality of pieces of data from the host device 300 based on the data transmission requests, and may control the memory device 100 to perform a write operation on the plurality of pieces of data according to the determined write order.

The read operation controller 230 may control a read operation of reading data from the memory device 100 in response to a read request received from the host device 300.

In an embodiment, the read operation controller 230 may receive a read operation request corresponding to a plurality of consecutive logical addresses from the host device 300. The read operation controller 230 may control the memory device 100 to read a plurality of pieces of data from the plurality of memory areas according to the sequential order of the plurality of logical addresses.

The host device 300 may control the overall operation of the computing system 10. In the present specification, for convenience of description, description will be made based on that the host device 300 communicates with the storage device 50 through a UFS communication method.

In an embodiment, the host device 300 may generate an input/output request, and may transmit the generated input/output request to the storage device 50. Here, the input/output request may include a write request, a read request or an erase request.

In an embodiment, the host device 300 may transmit the data according to the write order determined by the data transmission controller 220. For example, the host device 300 may receive respective data transmission requests corresponding to a plurality of pieces of data that are the target to be written from the data transmission controller 220. The host device 300 may provide the data requested to be transmitted to the write operation controller 210 in response to the data transmission requests.

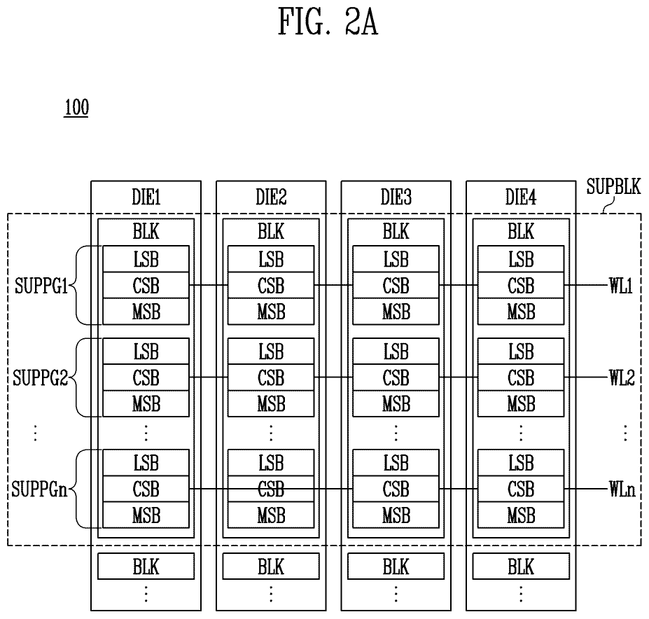

FIGS. 2A and 2B are diagrams illustrating a plurality of memory areas according to an embodiment of the present disclosure.

Referring to FIGS. 2A and 2B, the memory device 100 may include a plurality of dies DIE1 to DIE4. In the present specification, for convenience of description, description will be made based on that a plurality of memory areas are the plurality of dies DIE1 to DIE4. Although, in FIGS. 2A and 2B, the memory device 100 is illustrated as including four dies DIE1 to DIE4 for convenience of description, the embodiments of the present disclosure are not limited thereto, and the number of dies included in the memory device 100 may be less than 4, or may be equal to or greater than 4.

In an embodiment, the memory device may include a super block SUPBLK. The super block SUPBLK may include a plurality of memory blocks BLK included in different dies among the plurality of dies DIE1 to DIE4.

In an embodiment, the super block SUPBLK may include a plurality of pages. Each page may be composed of a plurality of memory cells connected to one word line. The super block SUPBLK may be connected to a plurality of word lines WL1 to WLn. A plurality of pages included in different dies while being connected to one word line may be referred to as a super page. For example, a plurality of pages included in the plurality of dies DIE1 to DIE4 while being connected to the first word line WL1 may form a first super page SUPPG1. Further, a plurality of pages included in the plurality of dies DIE1 to DIE4 while being connected to the second word line WL2 may form a second super page SUPPG2. Furthermore, a plurality of pages included in the plurality of dies DIE1 to DIE4 while being connected to the n-th word line WLn may form an n-th super page SUPPGn.

Each of the plurality of super pages SUPPG1 to SUPPGn may include a plurality of logical pages connected to one word line. Each of the plurality of logical pages may store a plurality of pieces of logical page data.

In an embodiment, each memory cell may be implemented as a triple-level cell. For example, referring to FIG. 2A, each of the plurality of super pages SUPPG1 to SUPPGn may include a most significant bit (MSB) page area in which MSB page data is stored, a central significant bit (CSB) page area in which CSB page data is stored, and a least significant bit (LSB) page area in which LSB page data is stored.

In an embodiment, each memory cell may be implemented as a quad-level cell. For example, referring to FIG. 2B, each of the plurality of super pages SUPPG1 to SUPPGn may include a quad significant bit (QSB) page area in which QSB page data is stored, an MSB page area, a CSB page area, and an LSB page area.

Hereinafter, for convenience of description, as shown in FIG. 2A, description will be made based on that each memory cell is implemented as a quad-level cell.

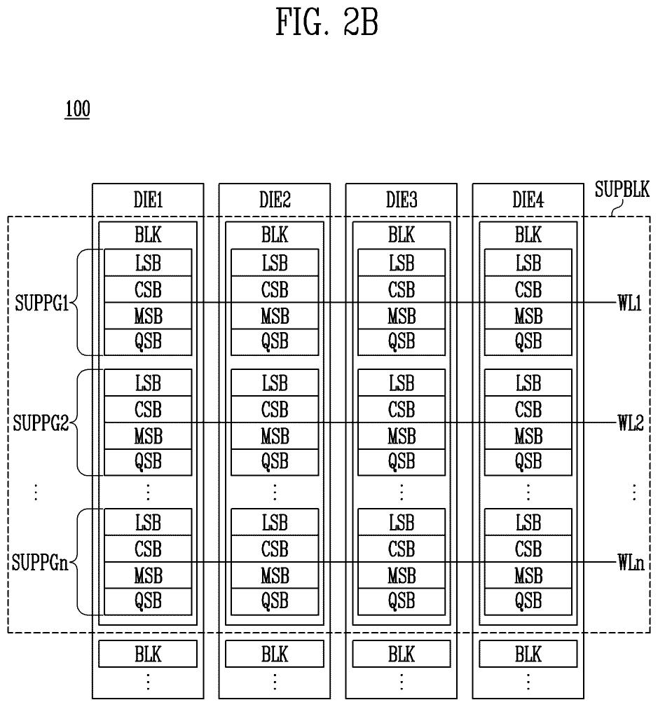

FIG. 3 is a diagram illustrating a write operation according to an embodiment of the present disclosure.

An i-th super page SUPPGi illustrated in FIG. 3 may refer to any of the plurality of super pages SUPPG1 to SUPPGn illustrated in FIG. 2A.

Referring to FIG. 3, the memory controller 200 may control a plurality of dies DIE1 to DIE4 to store a plurality of pieces of data DATA1 to DATA12 corresponding to a plurality of consecutive logical addresses LBA1 to LBA12 during a write operation.

In an embodiment, the memory controller 200 may control the memory device 100 to store the plurality of pieces of data DATA1 to DATA12 in a plurality of logical pages included in each of the plurality of memory areas, according to an interleaving scheme during a write operation on the plurality of pieces of data DATA1 to DATA12. In FIG. 3, for convenience of description, description will be made based on that the plurality of memory areas are the plurality of dies DIE1 to DIE4. For example, the memory controller 200 may control the memory device 100 to store the plurality of pieces of data DATA1 to DATA12 in a plurality of logical pages through an i-th word line WLi connected to the plurality of dies DIE1 to DIE4.

In an embodiment, the memory controller 200 may control the memory device 100 to store at least two pieces of data among the plurality of pieces of data DATA1 to DATA12 in a plurality of logical pages included in any of the plurality of memory areas through a one-shot write operation during a write operation performed on the one memory area.

In an embodiment, the memory controller 200 may determine the write order in which a plurality of pieces of data are to be stored in the plurality of memory areas, based on the order in which the pieces of data are read from the plurality of memory areas.

In an embodiment, the memory controller 200 may determine the write order so that a plurality of first pieces of data, corresponding to a plurality of first logical addresses that are nonconsecutive to each other among the plurality of pieces of data DATA1 to DATA12, are stored in a plurality of logical pages included in a first memory area among the plurality of memory areas. Further, the memory controller 200 may determine the write order so that a plurality of pieces of second data, corresponding to a plurality of second logical addresses consecutive to each of the plurality of first logical addresses, among the plurality of pieces of data DATA1 to DATA12, are stored in a plurality of logical pages included in a second memory area to be operated consecutively to the first memory area among the plurality of memory areas.

For example, the memory controller 200 may determine the write order so that first data DATA1 corresponding to the first logical address LBA1, fifth data DATA5 corresponding to the fifth logical address LBA5, and ninth data DATA9 corresponding to the ninth logical address LBA9 are stored in the plurality of logical pages included in the first die DIE1. The first logical address LBA1, the fifth logical address LBA5, and the ninth logical address LBA9 may not be consecutive to each other. Furthermore, the fifth logical address LBA5 may be consecutive to the fourth logical address LBA4, and the ninth logical address LBA9 may be consecutive to the eighth logical address LBA8. The memory controller 200 may provide a write command instructing a write operation to be performed according to the determined write order, the first data DATA1, the fifth data DATA5, and the ninth data DATA9 to the memory device 100.

Further, the memory controller 200 may determine the write order so that second data DATA2 corresponding to the second logical address LBA2, sixth data DATA6 corresponding to the sixth logical address LBA6, and tenth data DATA10 corresponding to the tenth logical address LBA10 are stored in the plurality of logical pages included in the second die DIE2. The second logical address LBA2, the sixth logical address LBA6, and the tenth logical address LBA10 may not be consecutive to each other. Furthermore, the second logical address LBA2 may be consecutive to the first logical address LBA1, the sixth logical address LBA6 may be consecutive to the fifth logical address LBA5, and the tenth logical address LBA10 may be consecutive to the ninth logical address LBA9. The memory controller 200 may provide a write command instructing a write operation to be performed depending on the determined write order, the second data DATA2, the sixth data DATA6, and the tenth data DATA10 to the memory device 100.

Also, the memory controller 200 may determine the write order so that third data DATA3 corresponding to the third logical address LBA3, seventh data DATA7 corresponding to the seventh logical address LBA7, and eleventh data DATA11 corresponding to the eleventh logical address LBA11 are stored in the plurality of logical pages included in the third die DIE3. The third logical address LBA3, the seventh logical address LBA7, and the eleventh logical address LBA11 may not be consecutive to each other. Furthermore, the third logical address LBA3 may be consecutive to the second logical address LBA2, the seventh logical address LBA7 may be consecutive to the sixth logical address LBA6, and the eleventh logical address LBA11 may be consecutive to the tenth logical address LBA10. The memory controller 200 may provide a write command instructing a write operation to be performed according to the determined write order, the third data DATA3, the seventh data DATA7, and the eleventh data DATA11 to the memory device 100.

Furthermore, the memory controller 200 may determine the write order so that fourth data DATA4 corresponding to the fourth logical address LBA4, eighth data DATA8 corresponding to the eighth logical address LBA8, and twelfth data DATA12 corresponding to the twelfth logical address LBA12 are stored in the plurality of logical pages included in the fourth die DIE4. The fourth logical address LBA4, the eighth logical address LBA8, and the twelfth logical address LBA12 may not be consecutive to each other. Furthermore, the fourth logical address LBA4 may be consecutive to the third logical address LBA3, the eighth logical address LBA8 may be consecutive to the seventh logical address LBA7, and the twelfth logical address LBA12 may be consecutive to the eleventh logical address LBA11. The memory controller 200 may provide a write command instructing a write operation to be performed depending on the determined write order, the fourth data DATA4, the eighth data DATA8, and the twelfth data DATA12 to the memory device 100.

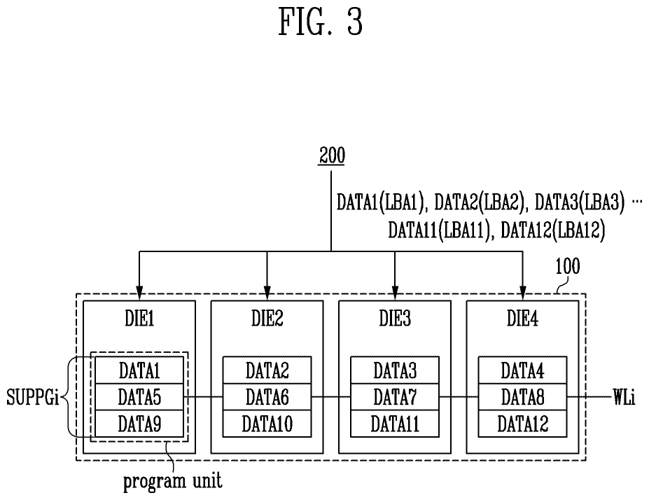

FIG. 4 is a diagram illustrating a write operation performed in a write order according to an embodiment of the present disclosure.

Referring to FIGS. 3 and 4, the storage device 50 may perform a write operation of storing a plurality of pieces of data in a plurality of memory areas according to the order in which the plurality of pieces of data are received from the host device 300.

At time T1, the host device 300 may sequentially provide the first data DATA1, the fifth data DATA5, the ninth data DATA9, the second data DATA2, the sixth data DATA6, the tenth DATA10, the third data DATA3, the seventh data DATA7, the eleventh data DATA11, the fourth data DATA4, the eighth data DATA8, and the twelfth data DATA12 to the storage device 50 according to the data transmission order determined by the storage device 50.

At time T2, the storage device 50 may receive all of the first data DATA1, the fifth data DATA5, and the ninth data DATA9. The storage device 50 may provide a write command, the first data DATA1, the fifth data DATA5, and the ninth data DATA9 to the first die DIE1. Overhead (OH) may occur while the write command, the first data DATA1, the fifth data DATA5, and the ninth data DATA9 are being provided to the first die DIE1. Thereafter, the first die DIE1 may perform a first write operation WR1 on the first data DATA1, the fifth data DATA5, and the ninth data DATA9. The first data DATA1, the fifth data DATA5, and the ninth data DATA9 may be stored in a plurality of logical pages included in the first die DIE1. For example, the first data DATA1 may be stored in an LSB page area included in the first die DIE1, the fifth data DATA5 may be stored in a CSB page area included in the first die DIE1, and the ninth data DATA9 may be stored in an MSB page area included in the first die DIE1.

At time T3, the storage device 50 may receive all of the second data DATA2, the sixth data DATA6, and the tenth data DATA10. The storage device 50 may provide a write command, the second data DATA2, the sixth data DATA6, and the tenth data DATA10 to the second die DIE2. Overhead (OH) may occur while the write command, the second data DATA2, the sixth data DATA6, and the tenth data DATA10 are being provided to the second die DIE2. Thereafter, the second die DIE2 may perform a second write operation WR2 on the second data DATA2, the sixth data DATA6, and the tenth data DATA10. The second data DATA2, the sixth data DATA6, and the tenth data DATA10 may be stored in a plurality of logical pages included in the second die DIE2. For example, the second data DATA2 may be stored in an LSB page area included in the second die DIE2, the sixth data DATA6 may be stored in a CSB page area included in the second die DIE2, and the tenth data DATA10 may be stored in an MSB page area included in the second die DIE2.

At time T4, the storage device 50 may receive all of the third data DATA3, the seventh data DATA7, and the eleventh data DATA11. The storage device 50 may provide a write command, the third data DATA3, the seventh data DATA7, and the eleventh data DATA11 to the third die DIE3. Overhead (OH) may occur while the write command, the third data DATA3, the seventh data DATA7, and the eleventh data DATA11 are being provided to the third die DIE3. Thereafter, the third die DIE3 may perform a third write operation WR3 on the third data DATA3, the seventh data DATA7, and the eleventh data DATA11. The third data DATA3, the seventh data DATA7, and the eleventh data DATA11 may be stored in a plurality of logical pages included in the third die DIE3. For example, the third data DATA3 may be stored in an LSB page area included in the third die DIE3, the seventh data DATA7 may be stored in a CSB page area included in the third die DIE3, and the eleventh data DATA11 may be stored in an MSB page area included in the third die DIE3.

At time T5, the storage device 50 may receive all of the fourth data DATA4, the eighth data DATA8, and the twelfth data DATA12. The storage device 50 may provide a write command, the fourth data DATA4, the eighth data DATA8, and the twelfth data DATA12 to the fourth die DIE4. Overhead (OH) may occur while the write command, the fourth data DATA4, the eighth data DATA8, and the twelfth data DATA12 are being provided to the fourth die DIE4. Thereafter, the fourth die DIE4 may perform a fourth write operation WR4 on the fourth data DATA4, the eighth data DATA8, and the twelfth data DATA12. The fourth data DATA4, the eighth data DATA8, and the twelfth data DATA12 may be stored in a plurality of logical pages included in the fourth die DIE4. For example, the fourth data DATA4 may be stored in an LSB page area included in the fourth die DIE4, the eighth data DATA8 may be stored in a CSB page area included in the fourth die DIE4, and the twelfth data DATA12 may be stored in an MSB page area included in the fourth die DIE4.

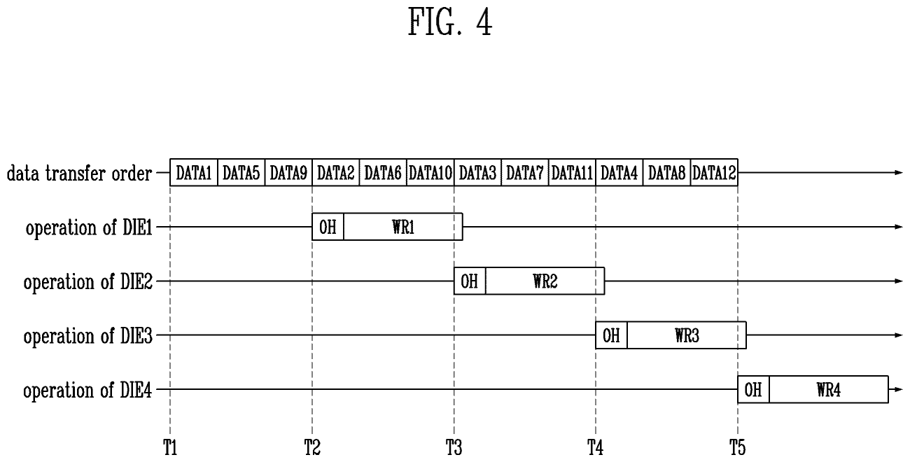

FIG. 5 is a sequence diagram illustrating data transmission requested from a host device in a write order according to an embodiment of the present disclosure.

Referring to FIG. 5, the storage device 50 may sequentially provide data transmission requests corresponding to each of a plurality of pieces of data, to the host device 300 so that the plurality of pieces of data are transmitted according to a determined write order. The host device 300 may provide the plurality of pieces of data to the storage device according to the order in which the respective data transmission requests corresponding to each of the plurality of pieces of data are received from the storage device 50.

At operation S51, the host device 300 may transmit a write operation request WREQ for a plurality of pieces of data DATA1 to DATA12 corresponding to a plurality of logical addresses to the storage device 50. In an embodiment, the host device 300 and the storage device 50 may transmit and receive data through a protocol information unit (PIU). For example, the write operation request WREQ may be transmitted in the form of a command protocol information unit (i.e., command UFS protocol information unit (UPIU)).

At operation S52, the storage device 50 may transmit a data transmission request DREQ1 for the first data DATA1 to the host device 300. The data transmission request DREQ1 may be transmitted in the form of a Ready To Transfer protocol information unit (READY TO TRANSFER UPIU). The following other data transmission requests may also be transmitted in the form of the Ready to Transfer protocol information unit.

At operation S53, the host device 300 may transmit the first data DATA1 to the storage device 50. The first data DATA1 may be transmitted in the form of Data Out protocol Information Unit (DATA OUT UPIU). The following other pieces of data may also be transmitted in the form of a Data Out protocol information unit (DATA OUT UPIU).

At operation S54, the storage device 50 may transmit a data transmission request DREQ2 for the fifth data DATA5 to the host device 300.

At operation S55, the host device 300 may transmit the fifth data DATA5 to the storage device 50.

At operation S56, the storage device 50 may transmit a data transmission request DREQ3 for the ninth data DATA9 to the host device 300.

At operation S57, the host device 300 may transmit the ninth data DATA9 to the storage device 50.

At operation S58, the storage device 50 may transmit a data transmission request DREQ4 for the second data DATA2 to the host device 300.

At operation S59, the host device 300 may transmit the second data DATA2 to the storage device 50.

Although not illustrated in FIG. 5, the storage device 50 may also sequentially receive the sixth data DATA6, the tenth data DATA10, the third data DATA3, the seventh data DATA7, the eleventh data DATA11, the fourth data DATA4, the eighth data DATA8, and the twelfth data DATA12 from the host device 300 in response to respective data transmission requests according to the determined write order.

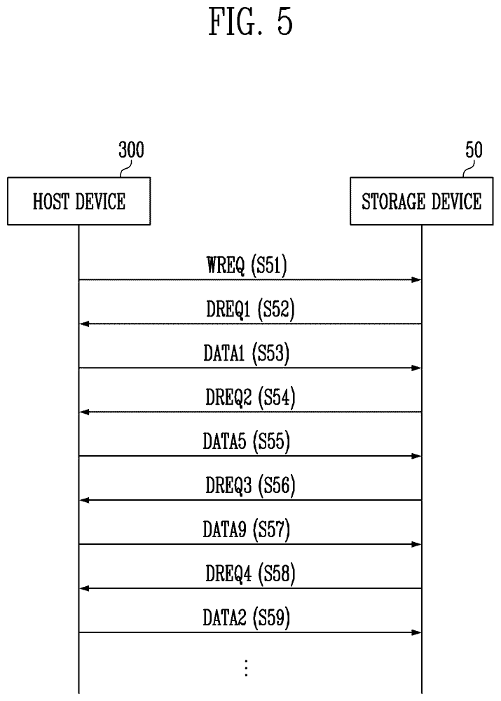

FIG. 6 is a sequence diagram illustrating data transmission requested from a host device in a write order according to an embodiment of the present disclosure.

Referring to FIG. 6, at operation S61, the host device 300 may transmit a write operation request WREQ for a plurality of pieces of data DATA1 to DATA12 corresponding to a plurality of logical addresses to the storage device 50.

At operation S62, the storage device 50 may transmit a data transmission request DREQ1 for first data DATA1, fifth data DATA5, and ninth data DATA9 to the host device 300.

At operation S63, the host device 300 may transmit the first data DATA1, the fifth data DATA5, and the ninth data DATA9 to the storage device 50.

At operation S64, the storage device 50 may transmit a data transmission request DREQ2 for second data DATA2, sixth data DATA6, and tenth data DATA10 to the host device 300.

At operation S65, the host device 300 may transmit the second data DATA2, the sixth data DATA6, and the tenth data DATA10 to the storage device 50.

At operation S66, the storage device 50 may transmit a data transmission request DREQ3 for third data DATA3, seventh data DATA7, and eleventh DATA11 to the host device 300.

At operation S67, the host device 300 may transmit the third data DATA3, the seventh data DATA7, and the eleventh DATA11 to the storage device 50.

At operation S68, the storage device 50 may transmit a data transmission request DREQ4 for fourth data DATA4, eighth data DATA8, and twelfth DATA12 to the host device 300.

At operation S69, the host device 300 may transmit the fourth data DATA4, the eighth data DATA8, and the twelfth DATA12 to the storage device 50.

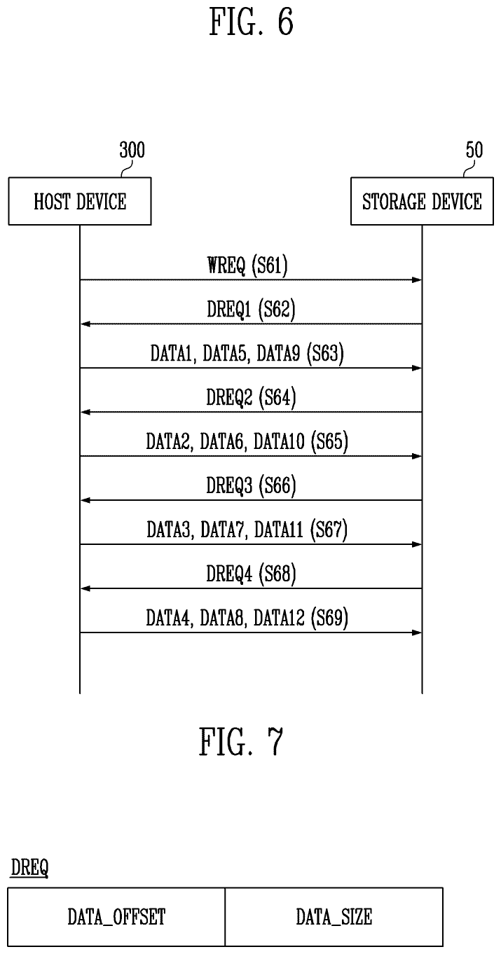

FIG. 7 is a diagram illustrating a data transmission request according to an embodiment of the present disclosure.

Referring to FIG. 7, the data transmission request DREQ may include offset information DATA_OFFSET indicating a logical address corresponding to each of a plurality of pieces of data and size information DATA_SIZE of each of the plurality of pieces of data.

For example, the write operation request of the host device 300 may include information about the expected transfer length or size of the entire data. The offset information DATA_OFFSET may refer to an offset indicating a logical address corresponding to each piece of data in the entire data length. The offset information DATA_OFFSET may be composed of data buffer offset-type register values. The size information DATA_SIZE may be information indicating the size of each piece of data, and may be composed of data transfer count-type register values.

In an embodiment, the host device 300 may enable or disable a function of controlling the data transmission order of the storage device 50. For example, when the host device 300 enables the function of controlling the data transmission order, the host device 300 may transmit requested data in response to the data transmission request DREQ of the storage device 50. On the other hand, when the host device 300 disables the function of controlling the data transmission order, the host device 300 may transmit pieces of data according to the order of a plurality of logical addresses, regardless of the data transmission request DREQ of the storage device 50.

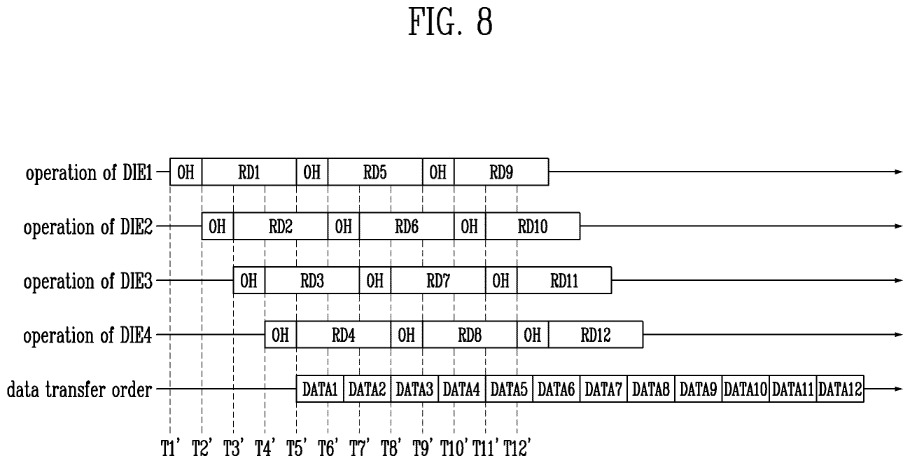

FIG. 8 is a diagram illustrating a read operation performed according to an embodiment of the present disclosure.

In an embodiment, the read operation may be an operation of consecutively reading a plurality of pieces of data stored in a plurality of logical pages from each of a plurality of memory areas, and of reading data stored in any of the plurality of logical pages from the plurality of memory areas according to an interleaving scheme.

In an embodiment, the storage device 50 may sequentially read the plurality of logical pages included in each of the plurality of memory areas, through one word line connected to the plurality of memory areas during the read operation on the plurality of pieces of data that are stored therein. In this case, the storage device 50 may control the memory device 100 to read pieces of data stored in a logical page area included in each of the plurality of memory areas, among the plurality of logical pages, according to the interleaving scheme. Further, pieces of data stored in a logical page area may correspond to consecutive logical addresses.

Referring to FIGS. 3 and 8, at time T1′, the storage device 50 may provide a read command and a physical address mapped to the first logical address LBA1 to the first die DIE1. Overhead (OH) may occur while the read command and the physical address mapped to the first logical address LBA1 are being provided to the first die DIE1. Thereafter, the first die DIE1 may perform a first read operation RD1 for reading the first data DATA1 stored in an LSB page area.

At time T2′, the storage device 50 may provide a read command and a physical address mapped to the second logical address LBA2 to the second die DIE2. Overhead (OH) may occur while the read command and the physical address mapped to the second logical address LBA2 are being provided to the second die DIE2. Thereafter, the second die DIE2 may perform a second read operation RD2 for reading the second data DATA2 stored in an LSB page area.

At time T3′, the storage device 50 may provide a read command and a physical address mapped to the third logical address LBA3 to the third die DIE3. Overhead (OH) may occur while the read command and the physical address mapped to the third logical address LBA3 are being provided to the third die DIE3. Thereafter, the third die DIE3 may perform a third read operation RD3 for reading the third data DATA3 stored in an LSB page area.

At time T4′, the storage device 50 may provide a read command and a physical address mapped to the fourth logical address LBA4 to the fourth die DIE4. Overhead (OH) may occur while the read command and the physical address mapped to the fourth logical address LBA4 are being provided to the fourth die DIE4. Thereafter, the fourth die DIE4 may perform a fourth read operation RD4 for reading the fourth data DATA4 stored in an LSB page area.

That is, the storage device 50 may read the first data DATA1, the second data DATA2, the third data DATA3, and the fourth data DATA4 stored in the LSB pages included in the plurality of dies DIE1 to DIE4, respectively, according to the interleaving scheme. In this case, the first data DATA1, the second data DATA2, the third data DATA3, and the fourth data DATA4 may correspond to consecutive logical addresses.

At time T5′, the storage device 50 may provide a read command and a physical address mapped to the fifth logical address LBA5 to the first die DIE1. Overhead (OH) may occur while the read command and the physical address mapped to the fifth logical address LBA5 are being provided to the first die DIE1. Thereafter, the first die DIE1 may perform a fifth read operation RD5 for reading the fifth data DATA5 stored in a CSB page area.

At time T6′, the storage device 50 may provide a read command and a physical address mapped to the sixth logical address LBA6 to the second die DIE2. Overhead (OH) may occur while the read command and the physical address mapped to the sixth logical address LBA6 are being provided to the second die DIE2. Thereafter, the second die DIE2 may perform a sixth read operation RD6 for reading the sixth data DATA6 stored in a CSB page area.

At time T7′, the storage device 50 may provide a read command and a physical address mapped to the seventh logical address LBA7 to the third die DIE3. Overhead (OH) may occur while the read command and the physical address mapped to the seventh logical address LBA7 are being provided to the third die DIE3. Thereafter, the third die DIE3 may perform a seventh read operation RD7 for reading the seventh data DATA7 stored in a CSB page area.

At time T8′, the storage device 50 may provide a read command and a physical address mapped to the eighth logical address LBA8 to the fourth die DIE4. Overhead (OH) may occur while the read command and the physical address mapped to the eighth logical address LBA8 are being provided to the fourth die DIE4. Thereafter, the fourth die DIE4 may perform an eighth read operation RD8 for reading the eighth data DATA8 stored in a CSB page area.

That is, the storage device 50 may read the fifth data DATA5, the sixth data DATA6, the seventh data DATA7, and the eighth data DATA8 stored in the CSB pages included in the plurality of dies DIE1 to DIE4, respectively, according to the interleaving scheme. In this case, the fifth data DATA5, the sixth data DATA6, the seventh data DATA7, and the eighth data DATA8 may correspond to consecutive logical addresses.

At time T9′, the storage device 50 may provide a read command and a physical address mapped to the ninth logical address LBA9 to the first die DIE1. Overhead (OH) may occur while the read command and the physical address mapped to the ninth logical address LBA9 are being provided to the first die DIE1. Thereafter, the first die DIE1 may perform a ninth read operation RD9 for reading the ninth data DATA9 stored in an MSB page area.

At time T10′, the storage device 50 may provide a read command and a physical address mapped to the tenth logical address LBA10 to the second die DIE2. Overhead (OH) may occur while the read command and the physical address mapped to the tenth logical address LBA10 are being provided to the second die DIE2. Thereafter, the second die DIE2 may perform a tenth read operation RD10 for reading the tenth data DATA10 stored in an MSB page area.

At time T11′, the storage device 50 may provide a read command and a physical address mapped to the eleventh logical address LBA11 to the third die DIE3. Overhead (OH) may occur while the read command and the physical address mapped to the eleventh logical address LBA11 are being provided to the third die DIE3. Thereafter, the third die DIE3 may perform an eleventh read operation RD11 for reading the eleventh data DATA11 stored in an MSB page area.

At time T12′, the storage device 50 may provide a read command and a physical address mapped to the twelfth logical address LBA12 to the fourth die DIE4. Overhead (OH) may occur while the read command and the physical address mapped to the twelfth logical address LBA12 are being provided to the fourth die DIE4. Thereafter, the fourth die DIE4 may perform a twelfth read operation RD12 for reading the twelfth data DATA12 stored in an MSB page area.

That is, the storage device 50 may read the ninth data DATA9, the tenth data DATA10, the eleventh data DATA11, and the twelfth data DATA12 stored in the MSB page areas included in the plurality of dies DIE1 to DIE4, respectively, according to the interleaving scheme. In this case, the ninth data DATA9, the tenth data DATA10, the eleventh data DATA11, and the twelfth data DATA12 may correspond to consecutive logical addresses.

In an embodiment, the storage device 50 may sequentially provide the first to twelfth data DATA1 to DATA12 to the host device 300. The first to twelfth data DATA1 to DATA12 may be provided to the host device 300 in the order of logical addresses respectively corresponding thereto.

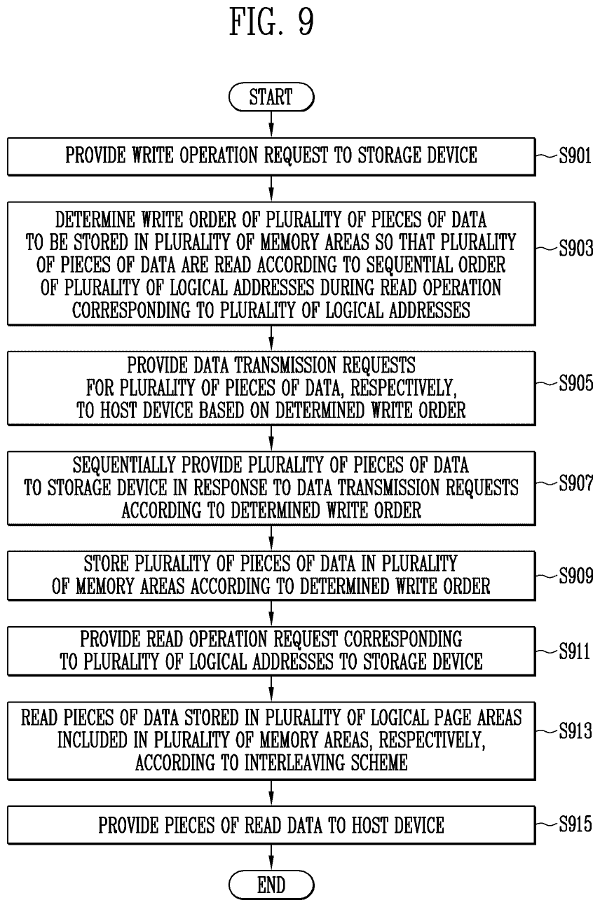

FIG. 9 is a flowchart illustrating a method of operating a computing system according to an embodiment of the present disclosure.

The method illustrated in FIG. 9 may be performed by, for example, the computing system 10 illustrated in FIG. 1.

Referring to FIG. 9, at operation S901, the host device 300 may provide a write operation request for a plurality of pieces of data corresponding to a plurality of consecutive logical addresses to the storage device 50.

At operation S903, the storage device 50 may determine the write order of a plurality of pieces of data so that the pieces of data are read from a plurality of memory areas according to the sequential order of the plurality of logical addresses during a read operation corresponding to the plurality of logical addresses.

For example, the storage device 50 may determine the write order so that data corresponding to a first logical address and data corresponding to a second logical address, among the plurality of pieces of data, are stored in a plurality of logical page areas included in a first memory area among the plurality of memory areas. Further, the storage device 50 may determine the write order so that data corresponding to a third logical address consecutive to the first logical address and data corresponding to a fourth logical address consecutive to the second logical address, among the plurality of pieces of data, are stored in a plurality of logical pages included in a second memory area to be operated consecutively to the first memory area among the plurality of memory areas. Here, the storage device 50 may determine the write order so that the second logical address is consecutive to the third logical address.

At operation S905, the storage device 50 may provide data transmission requests corresponding to each of the plurality of pieces of data, to the host device 300 according to the determined write order.

For example, the storage device 50 may sequentially provide the data transmission requests corresponding to each of the plurality of pieces of data, to the host device 300 according to the determined write order.

At operation S907, the host device 300 may sequentially provide the plurality of pieces of data to the storage device 50 in response to the data transmission requests according to the determined write order.

At operation S909, the storage device 50 may store the plurality of pieces of data in the plurality of memory areas according to the determined write order.

At operation S911, the host device 300 may provide a read operation request corresponding to a plurality of logical addresses to the storage device 50.

At operation S913, the storage device 50 may read the pieces of data stored in the plurality of logical pages included in each of the plurality of memory areas, according to an interleaving scheme.

For example, the storage device 50 may read data corresponding to the first logical address from the first memory area. The storage device 50 may read data corresponding to the third logical address from the second memory area. The storage device 50 may read data corresponding to the second logical address from the first memory area. The storage device 50 may read data corresponding to the fourth logical address from the second memory area.

At operation S915, the storage device 50 may provide pieces of read data to the host device 300.

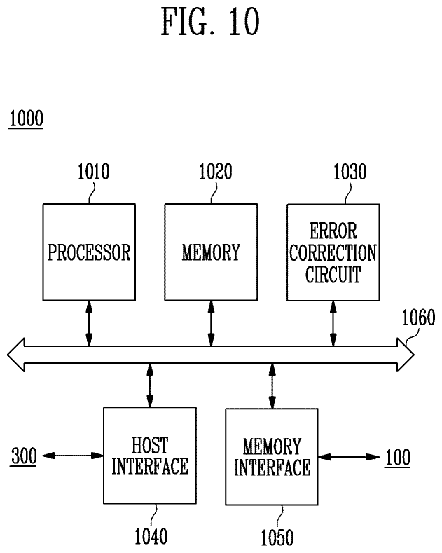

FIG. 10 is a diagram illustrating a memory controller according to an embodiment of the present disclosure.

A memory controller 1000 illustrated in FIG. 10 may refer to the memory controller 200 illustrated in FIG. 1.

Referring to FIG. 10, the memory controller 1000 may include a processor 1010, a memory 1020, an error correction circuit 1030, a host interface 1040, a memory interface 1050, and a communication bus 1060. The processor 1010, the memory 1020, the error correction circuit 1030, the host interface 1040, and the memory interface 1050 may communicate with each other through the communication bus 1060.

The processor 1010 may execute firmware, code or one or more instructions, which include various types of information required for the operation of the memory controller 1000. In an embodiment, the write operation controller 210, the data transmission controller 220, and the read operation controller 230 of FIG. 1 may be implemented using one or more components stored in the processor 1010.

In an embodiment, the processor 1010 may determine the order in which a plurality of pieces of data are to be stored in a plurality of memory areas, based on the order in which pieces of data are read from the plurality of memory areas, in response to a write operation request. The processor 1010 may provide data transmission requests corresponding to each of the plurality of pieces of data, to the host device 300 through the host interface 1040 so that the plurality of pieces of data are transmitted according to the determined order.

In an embodiment, the order in which the pieces of data are read from the plurality of memory areas may be determined such that a plurality of pieces of data stored in each of a plurality of logical pages from the plurality of memory areas are consecutively read, and data stored in one of the plurality of logical pages is read from the plurality of memory areas according to the interleaving scheme.

The memory 1020 may be used as a buffer memory, a cache memory, a working memory, or the like.

Further, the memory 1020 may store the firmware, code or one or more instructions including various types of information required for the operation of the memory controller 1000.

The error correction circuit 1030 may perform error correction when data is stored in the memory device 100 or when data is read from the memory device 100. For example, the error correction circuit 1030 may perform error correcting code (ECC) encoding based on data to be written to the memory device 100. The encoded data may be transferred to the memory device 100. The error correction circuit 1030 may perform error correcting code decoding on data received from the memory device 100.

The memory controller 1000 may communicate with an external device (e.g., the host device 300, an application processor or the like) through the host interface 1040.

The memory controller 1000 may communicate with the memory device 100 through the memory interface 1050. The memory controller 1000 may transmit a command, an address, a control signal, or the like to the memory device 100 and receive data from the memory device 100, through the memory interface 1050.

According to the embodiments of the present disclosure, there are provided a computing system that is capable of improving the performance of a read operation and a method of operating the computing system.

The inventive concept has been disclosed in conjunction with some embodiments as described above. Those skilled in the art will appreciate that various modifications, additions and substitutions are possible, without departing from the scope and spirit of the present disclosure. Accordingly, the embodiments disclosed in the present specification should be considered from not a restrictive standpoint but an illustrative standpoint. The scope of the inventive concept is not limited to the above descriptions but defined by the accompanying claims, and all distinctive features in the equivalent scope should be construed as being included in the inventive concept. Furthermore, the embodiments may be combined to form additional embodiments.

What is claimed is:

1. A computing system comprising:
a host device configured to output a write operation request for a plurality of pieces of data corresponding to a plurality of consecutive logical addresses; and
a storage device including a plurality of memory areas to be operated according to an interleaving scheme, the storage device configured to, when the write operation request is received from the host device, determine a write order of the plurality of pieces of data so that the pieces of data are read from the plurality of memory areas according to a sequential order of the plurality of logical addresses during a read operation, and provide, to the host device, data transmission requests corresponding to each of the plurality of pieces of data, based on the determined write order.

2. The computing system according to claim 1, wherein the host device is configured to provide the plurality of pieces of data to the storage device according to an order in which the data transmission requests corresponding to each of the plurality of pieces of data are received from the storage device.

3. The computing system according to claim 2, wherein the storage device is configured to perform a write operation of storing the plurality of pieces of data in the plurality of memory areas according to an order in which the pieces of data are received from the host device.

4. The computing system according to claim 3, wherein each of the plurality of memory areas comprises a plurality of logical pages corresponding to one word line.

5. The computing system according to claim 4, wherein the storage device is configured to store the plurality of pieces of data in the plurality of logical pages included in each of the plurality of memory areas according to the interleaving scheme.

6. The computing system according to claim 5, wherein, during the write operation, the storage device is configured to store at least two pieces of data among the plurality of pieces of data in the plurality of logical pages included in one of the plurality of memory areas.

7. The computing system according to claim 4, wherein the storage device is configured to determine the write order so that a plurality of pieces of first data are stored in the plurality of logical pages included in a first memory area among the plurality of memory areas, the plurality of pieces of first data corresponding to a plurality of first logical addresses that are not consecutive to each other among the plurality of pieces of data.

8. The computing system according to claim 7, wherein the storage device is configured to determine the write order so that a plurality of pieces of second data are stored in the plurality of logical pages included in a second memory area operating consecutively to the first memory area among the plurality of memory areas, the plurality of pieces of second data corresponding to a plurality of second logical addresses consecutive to each of the plurality of first logical addresses, among the plurality of pieces of data.

9. The computing system according to claim 4, wherein the read operation is performed to consecutively read the plurality of pieces of data stored in each of the plurality of logical pages from each of the plurality of memory areas, according to the interleaving scheme.

10. The computing system according to claim 1, wherein each of the data transmission requests includes offset information indicating a logical address corresponding to each of the plurality of pieces of data among the plurality of logical addresses, and size information of each of the plurality of pieces of data.

11. A method of operating a storage device including a plurality of memory areas operating according to an interleaving scheme, the method comprising:
receiving, from a host device, a write operation request for a plurality of pieces of data corresponding to a plurality of consecutive logical addresses;
determining a write order of the plurality of pieces of data so that the pieces of data are read from the plurality of memory areas according to a sequential order of the plurality of logical addresses during a read operation corresponding to the plurality of logical addresses;
providing, to the host device, data transmission requests corresponding to each of the plurality of pieces of data, based on the determined write order;
sequentially receiving, from the host device, the plurality of pieces of data corresponding to the data transmission requests according to the determined write order; and
storing the plurality of pieces of data in the plurality of memory areas according to the determined write order.

12. The method according to claim 11, wherein sequentially receiving the plurality of pieces of data comprises sequentially receiving the plurality of pieces of data from the host device according to an order in which the data transmission requests corresponding to each of the plurality of pieces of data are provided by the storage device.

13. The method according to claim 11, wherein determining the write order comprises:
determining the write order so that data corresponding to a first logical address and data corresponding to a second logical address, among the plurality of pieces of data are stored in a plurality of logical pages included in a first memory area among the plurality of memory areas; and
determining the write order so that data corresponding to a third logical address consecutive to the first logical address and data corresponding to a fourth logical address consecutive to the second logical address, among the plurality of pieces of data are stored in a plurality of logical pages included in a second memory area to be operated consecutively to the first memory area among the plurality of memory areas.

14. The method according to claim 13, wherein the second logical address is consecutive to the third logical address.

15. The method according to claim 14, further comprising:
receiving, from the host device, a read operation request corresponding to the plurality of logical addresses;
reading pieces of data stored in a plurality of logical pages included in each of the plurality of memory areas according to the interleaving scheme; and
providing the read pieces of data to the host device.

16. The method according to claim 15, wherein reading the pieces of data comprises:
reading data corresponding to the first logical address from the first memory area;
reading data corresponding to the third logical address from the second memory area;
reading data corresponding to the second logical address from the first memory area; and
reading data corresponding to the fourth logical address from the second memory area.

17. A computing system comprising:
a host device configured to output a write operation request for a plurality of pieces of data corresponding to a plurality of consecutive logical addresses;
a memory device including a plurality of memory areas operating according to an interleaving scheme; and
a memory controller, in response to the write operation request, configured to determine an order in which the plurality of pieces of data are to be stored in the plurality of memory areas based on an order in which the pieces of data are read from the plurality of memory areas, and provide, to the host device, data transmission requests corresponding to each of the plurality of pieces of data so that the plurality of pieces of data are transmitted from the host device according to the determined order.

18. The computing system according to claim 17, wherein each of the plurality of memory areas includes a plurality of logical pages corresponding to one word line.

19. The computing system according to claim 18, wherein the order in which the pieces of data are read from the plurality of memory areas is determined so that the plurality of pieces of data stored in the plurality of logical pages are consecutively read from each of the plurality of memory areas, according to the interleaving scheme.

20. The computing system according to claim 17, wherein:
the host device is configured to provide the plurality of pieces of data to the memory controller according to an order in which the data transmission requests corresponding to each of the plurality of pieces of data are received from the memory controller; and
the memory controller is configured to control the memory device to store the plurality of pieces of data in the plurality of memory areas according to an order in which the plurality of pieces of data are received from the host device.
